(19) United States
(12) Patent Application Publication
(10) Pub. No.: US 2009/0096810 A1
(43) Pub. Date: Apr. 16, 2009

(54) METHOD FOR SELECTIVELY REMOTING WINDOWS

(76) Inventor: Brian D. Green, Santa Barbara, CA (US)

Correspondence Address: Goodwin Procter LLP, Exchange Place, Boston, MA, 02109, US

(21) Appl. No.: 11/870,926

(22) Filed: Oct. 11, 2007

(51) Int. Cl. G09G 5/00

(52) U.S. Cl. 345/620

(57) ABSTRACT

Methods and apparatus for the display of an image at a remote computer, where the image includes a graphical object to be at least partially omitted from the image displayed at the remote computer. Different regions of the desktop are identified and processed by different capture methods, in such a way as to achieve the desired result while keeping the computational cost low. Applications include the sharing of a local user's desktop with remote users without sharing a local user interface.

### FIELD OF THE INVENTION

This invention relates to online collaboration software, and more particularly to the selective sharing of windows from a local user's desktop with remote users.

### BACKGROUND

Online collaboration software allows computer users at different locations to share access to the same data. As an example, a remote desktop sharing application allows a local computer user, such as the host of a teleconference, to “capture” the contents of his or her computer display and transmit it in real time to the users of remote computers. One example of such software is GoToMeeting, sold by Citrix Systems of Fort Lauderdale, Fla. The desktop remotely shared (or “remoted”) may include all or a subset of the windows that the local user can see. While the local user typically needs to install desktop sharing software, remote users may view the desktop by using standard web browsers.

The local user sharing his or her desktop typically requires some form of user interface (UI) to operate the online collaboration software. The UI may take the form of a dedicated window or other graphical object displayed on the desktop. For example, the UI may inform the local user about who is currently receiving the desktop, or it may allow users to “chat” in a text window. Also, the UI may allow the local user to start, stop and otherwise control the remote desktop sharing process.

While, as mentioned above, remote users generally see an identical copy of the local user's desktop, it may be desirable to not transmit the UI to remote users, for two reasons. First, the local user may not want the remote users to see the contents of the UI for privacy reasons. Second, the UI is mostly a nuisance for the remote users, as it distracts them from viewing the desktop. Accordingly, it may be desirable to employ a desktop capture technique that has the capability of omitting the UI from the version of the desktop that is captured and transmitted to remote users.

Desktop metaphors provide the user interface for the vast majority of personal computer operating systems. Desktop environments such as Microsoft Windows and Mac OS X manage a plurality of windows arranged in a “z-order” that mimics the way sheets of paper overlap on a physical desktop. When windows overlap each other, the top window in the z-order will take precedence over the other windows in the desktop rendering process. In other words, windows that are higher in the z-order will appear to a user to be located in front of windows that are lower in the z-order.

In modern desktop environments, a window can be opaque or translucent. We will use the term “translucent window” to indicate a window with some degree of transparency over at least part of its area. While an opaque window completely hides the contents of the display underneath it, a translucent window shows to some extent the contents underneath it. When a translucent window overlaps other windows that are lower in the z-order, the contents of the overlapped windows are blended and displayed with the content of the translucent window, rather than blocking the contents of the overlapped windows as an opaque window would do. Translucent windows may also be stacked, such that the contents of multiple translucent windows adjacent in the z-order are blended and the result displayed to the end user.

A translucent window has the advantage of conveying information to the user without obscuring the underlying desktop. Translucent windows are typically employed to display service information, such as drop-down menus. A translucent window may also be partly opaque, i.e., some pixels may be opaque and some may be translucent.

No satisfactory solution has been proposed for the problem of removing a translucent window from a remoted desktop image that includes other translucent windows. Typically, desktop environments such as Microsoft Windows include functionalities for the rendering of a desktop with or without all translucent windows, but not for the selective display or removal of certain translucent windows. While it would be trivial to hide a window by removing it from the window hierarchy and re-rendering the entire desktop, this approach is not practical for collaboration applications because rendering an entire window hierarchy in the presence of translucent windows may be computationally expensive. Accordingly, there is a need for methods and apparatus that permit the selective removal of a translucent window from a desktop image that includes other translucent windows.

### SUMMARY OF THE INVENTION

The invention solves the aforementioned problems by identifying different regions of an image to be processed by different capture methods. In each region, the invention may select any of several alternative capture methods that achieve the desired result. In particular, the capture methods may be selected with the goal of keeping the total computational cost within acceptable bounds. The particular choice of the criteria by which the regions are identified, and the capture methods to be applied in each region, will generally depend on the functionalities provided by the operating system and the underlying hardware and on the available processing capabilities.

In a first aspect, the invention provides a method for the display of an image at a remote computer, where the image includes a graphical object to be at least partially omitted from the image displayed at the remote computer. The method may comprise the steps of determining a first region in the image, the first region comprising at least part of the graphical object, selectively capturing pixels that fall outside the first region, and selectively re-rendering pixels that fall within the first region to omit the graphical object. In an embodiment, the first region comprises the entirety of the graphical object, and it may also coincide with the area of the image that is covered by the graphical object.

In a further embodiment, the image comprises opaque and translucent objects, and the graphical object is a translucent object. The method may further include the steps of determining a second region in the image, where the second region comprises translucent objects not overlapping with the graphical object, and determining a third region in the image, where the third region does not comprise translucent objects. The method may also include selectively capturing pixels of the second region including both opaque and translucent objects, and selectively capturing pixels of the third region including opaque objects only. The opaque and translucent objects may be arranged in a hierarchy, and the step of re-rendering pixels may include retrieving the contents of each opaque and translucent object that intersects the first region and composing the contents according to their order in the hierarchy and their being opaque or translucent.

In a further embodiment, the method may also comprise the steps of updating the first region in response to changes in the graphical object, and/or updating the first region at predetermined times. The method may also include updating at least one of the first, second and third regions in response to changes in the number and position of translucent objects. The method may also include the steps of selectively rendering updated pixels in the first region, detecting a change by comparing the updated pixels with previously rendered pixels, and, if a change is detected, updating at least one of the first, second and third regions. In an embodiment, the image is captured at a first average frequency, and the step of selectively rendering updated pixels is performed at a second average frequency which is substantially lower than the first average frequency.

In a particular embodiment of the invention, the image represents a desktop of a local computer system, and the graphical object represents the user interface of an application running on the local computer system.

In a different aspect, the invention provides an apparatus for the display of an image at a remote computer, where the image includes a graphical object to be at least partially omitted from the image displayed at the remote computer. The apparatus may include a facility for determining a first region in the image, the first region comprising at least part of the graphical object, a facility for selectively capturing pixels that fall outside the first region, and a facility for selectively re-rendering pixels that fall within the first region to omit the graphical object.

In yet another aspect, the invention provides a computer-readable medium storing a program for the display of an image at a remote computer, where the image includes a graphical object to be at least partially omitted from the image displayed at the remote computer. The program may comprise instructions for determining a first region in the image, the first region comprising at least part of the graphical object, selectively capturing pixels that fall outside the first region, and selectively re-rendering pixels that fall within the first region to omit the graphical object.

### BRIEF DESCRIPTION OF THE DRAWINGS

In the drawings, like reference characters generally refer to the same features or steps throughout the different views. The drawings are not necessarily to scale, emphasis instead generally being placed upon illustrating the principles of the invention. In the following description, various embodiments of the invention are described with reference to the following drawings, in which:

FIGS. 1A and 1B show an example of operation of one embodiment of the present invention;

FIG. 2 is a flow chart illustrating the operation of a first embodiment of the invention;

FIGS. 3A and 3B show an example of the operation of this first embodiment of the invention;

FIG. 4 is a flow chart of a custom rendering algorithm utilized in various embodiments of the present invention;

FIG. 5 is a flow chart illustrating the operation of a second embodiment of the invention;

FIG. 6 is a flow chart describing the high-level operation of the second embodiment;

FIGS. 7A and 7B show one example of the operation of the second embodiment of the invention;

FIGS. 8A and 8B show another example of the operation of the second embodiment of the invention; and

FIGS. 9A and 9B show yet another example of the operation of the second embodiment of the invention.

### DETAILED DESCRIPTION

Several embodiments of the invention will now be described that utilize different criteria for identifying capture regions and capture methods to be applied in each region. Two aspects will be described separately, namely, the partial transmission of a window hierarchy and the updating of capture region boundaries in the presence of dynamic desktop changes.

### Partial Transmission of a Window Hierarchy

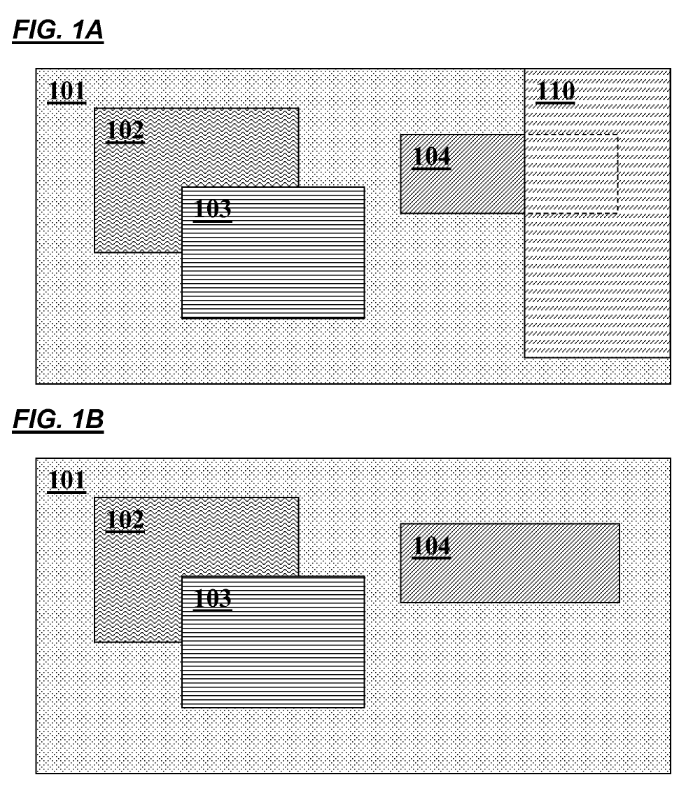

FIGS. 1A and 1B show an example of the operation of one embodiment of the present invention. FIG. 1A illustrates a simple desktop as it may be seen by a local user. Desktop 100 includes opaque desktop background 101, windows 102, 103 and 104, which may be opaque or translucent, and translucent UI window 110. While conventional rectangular windows are shown to facilitate the current discussion, the invention applies to any rectangular or non-rectangular region or window, or any arbitrarily shaped area suitable for communication to a remote computer. Similarly, although the present discussion focuses on the elimination of a particular translucent window or windows from a desktop having a plurality of translucent and opaque windows transmitted to a remote user, it is readily apparent that embodiments of the present invention in operation similarly allow for the exclusion of a particular opaque window or windows, or any combination of opaque and translucent windows from the transmitted desktop.

In the example desktop shown in FIG. 1A, the UI 110 is partially translucent so that the local user can see what the remote users are seeing, namely the areas of desktop 101 and window 104 that would otherwise be totally obscured. Since modern desktop environments directly support translucent windows, a translucent UI may be implemented by standard system calls.

Window 104 is only partially obscured by the translucent UI 110, as shown by its outline in dashed lines. Since the UI 110 is translucent, the local user is able to see window 104 through the UI 110. FIG. 1B shows the desktop as it should be captured by the desktop sharing application and transmitted to the remote users. Removing the UI 110 from FIG. 1A reveals not only the part of the desktop 101 that was partially obscured by the UI 110, but also the part of window 104 that was partially obscured by UI 110. In this way remote users can view the local user's entire desktop, as shown in FIG. 1B, without being distracted by the UI 110 that the local user employs to operate the collaboration software.

In an alternative mode of operation, one may want to remove only part of the UI 110, leaving in place some portion of the UI 110 that may be useful to remote users (e.g., a “chat” window, a list of participants, etc.). The following description would equally apply to the removal of only part of the UI from the desktop transmitted to a remote user. Likewise, embodiments of the invention may be used for the removal of other types of graphical objects from the desktop transmitted to a remote user, for example, windows showing debugging information during program development, or other applications that the local user may not want the remote users to see, such as email or instant messaging applications.

Removing a translucent UI from a desktop including other translucent windows presents a unique technical problem. Typically, desktop environments such as Microsoft Windows provide system calls to capture part of the desktop, for example a rectangular region on the desktop. Such system calls also provide the option of capturing the content of all of the opaque windows present in the specified region, all of the translucent windows present in the specified region, or both. However these calls do not support the capture of the content of a subset of the translucent windows present in the specified region. Accordingly, there is a problem transmitting the desktop to a remote user if the desktop includes a plurality of translucent windows and the local user only wants to transmit a subset of all of the translucent windows present in a region of the desktop. Using the functionality available from the operating system, one would typically be faced with the choice of either transmitting the desktop with all of its translucent windows, including the UI, or transmitting a desktop without any of the translucent windows. The latter choice would prevent the sharing of those translucent windows that the local user may want to transmit to remote users, such as portions of the desktop that are by default rendered as translucent windows.

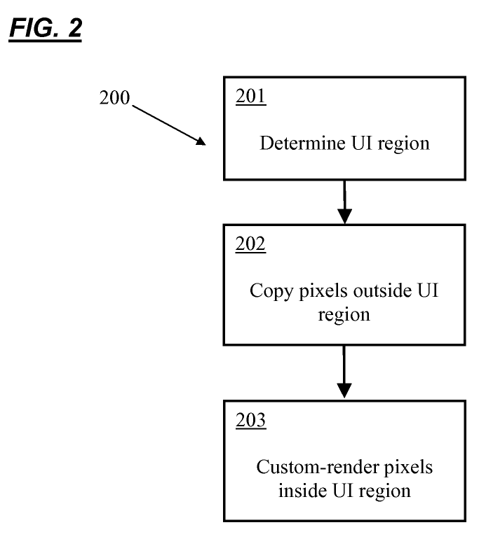

FIG. 2 is a flow chart illustrating the operation of a first embodiment 200 of the invention. In this embodiment 200, a desktop to be transmitted to remote users, including only a subset of the windows in the original desktop, is captured starting from an already rendered desktop image (e.g., utilizing the contents of the frame buffer on a display device). First, the algorithm determines a region in the desktop which encompasses at least part of the UI, and typically coincides with the area covered by the UI (Block 201). The algorithm selectively copies (i.e., “scrapes”) pixels that fall outside the region to partially construct the desktop image to be transmitted (Block 202). The algorithm selectively custom-renders pixels that fall within the region that includes the UI (Block 203). In this way, the algorithm custom-renders the windows hierarchy only where necessary.

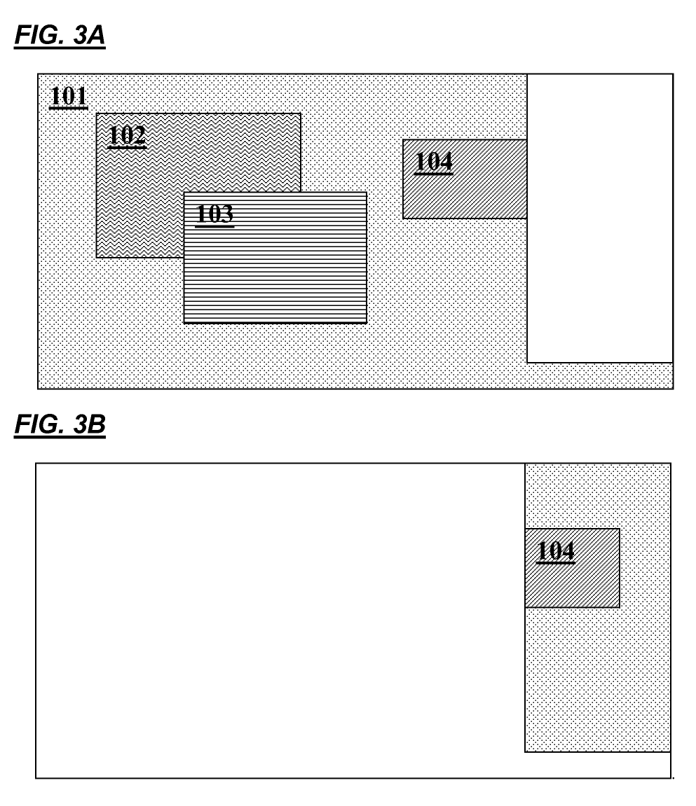

FIGS. 3A and 3B show an example of the operation of this first embodiment of the invention utilizing the example desktop illustrated in FIG. 1A. The desktop is divided into two regions. The first region includes the entire area of the desktop that is not covered by the UI 110, as shown in FIG. 3A. This area may be captured and transmitted without modifications. The second region includes the area of the desktop that includes the UI 110 and all the windows that lie beneath the translucent UI 110 in z-order, as shown in FIG. 3B. One way to eliminate the translucent UI 110 from this second region would be to directly modify the desktop image and draw over the region occupied by the UI 110 with a solid color or pattern. However this would not achieve the desired result. In the example of FIG. 3B, the content of part of window 104 and the desktop 101 overlapping the area with UI 110 would be lost. Accordingly, in this embodiment of the invention, the pixels in the region occupied by the UI 110 are custom-rendered, thus creating the impression that the window was never there. This approach is computationally efficient because the majority of the desktop for communication to the remote user is obtained by a simple system call to the operating system, while the slower custom rendering process is only carried out for a limited part of the desktop.

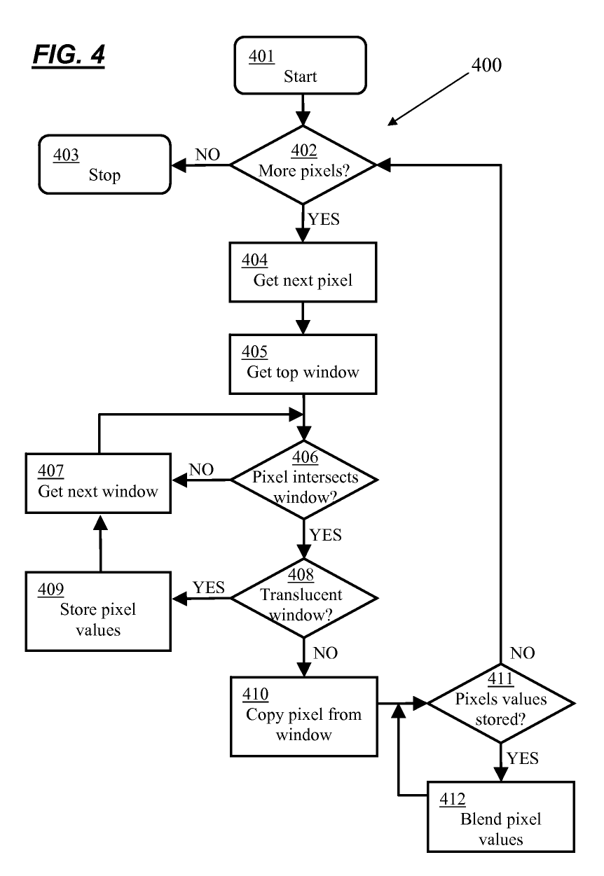

FIG. 4 is a flow chart of the custom rendering algorithm. In the first embodiment of the invention, this algorithm may be used for example in a region of the desktop where a window to be excluded from the capture process overlaps other windows that are to be captured. An example would be the region where a translucent UI overlaps a translucent window and an opaque desktop, both of which are to be transmitted to remote users. The custom rendering algorithm utilizes the window hierarchy to re-render a limited region of the desktop, while excluding the UI 110 from the process. Since this can be a computationally expensive operation, it should be carried out efficiently.

In the description of the algorithm that follows, it is assumed that the window(s) not to be captured and transmitted have already been excluded from the window hierarchy. For example, in one embodiment the collaboration software can determine the process ID assigned to it by the underlying operating system. During the subsequent custom-rendering process, the collaboration software can use the process ID associated with each window to determine whether it should be excluded. In the case in which the UI is to be excluded, the window corresponding to the UI will be associated to the process ID of the collaboration software. It is understood that any other known method for identifying windows or other graphical objects may be used.

The algorithm starts at Block 401 and iterates over each pixel in the custom-rendering region (Block 402). If there are no more pixels to be processed, the algorithm terminates (Block 403). If there is at least one more pixel to be processed, the algorithm selects the next pixel to be processed (Block 404). The algorithm then selects the top-most window in the z-order (Block 405) and checks if that window intersects the pixel that is being drawn (Block 406). If the window does not intersect the pixel being drawn, the algorithm selects the next window in the z-order (block 407). If the window intersects the pixel being drawn, and if the pixel in the window is translucent (Block 408), the color and opacity of the pixel in the window are stored for later use (Block 409), and the next window in the z-order is selected (Block 407). If instead the pixel in the window is opaque, the pixel is copied from the window content (Block 410). Accordingly, even assuming the presence of an arbitrary number of translucent windows in the hierarchy, the algorithm necessarily stops at the desktop background, which is the window that is always at the bottom of the z-order and is always opaque. As a last step for that particular pixel, if any translucent pixels were encountered on the way down the z-order (Block 411), the values of those translucent pixels and the final opaque pixel are blended to obtain the final value for that pixel (Block 412). Once all the pixel values have been blended, the algorithm returns to the beginning of the pixel loop (Block 402) for processing of further pixels.

While the algorithm has been described for a single pixel, for reasons of efficiency it may be preferable to operate on whole rectangular regions. A region of pixels is merely an aggregation of pixels and the previously described custom-rendering algorithm may easily be extended to region-wide operation by changing each step to simultaneously operate on a region, e.g., a set of contiguous or adjacent pixels.

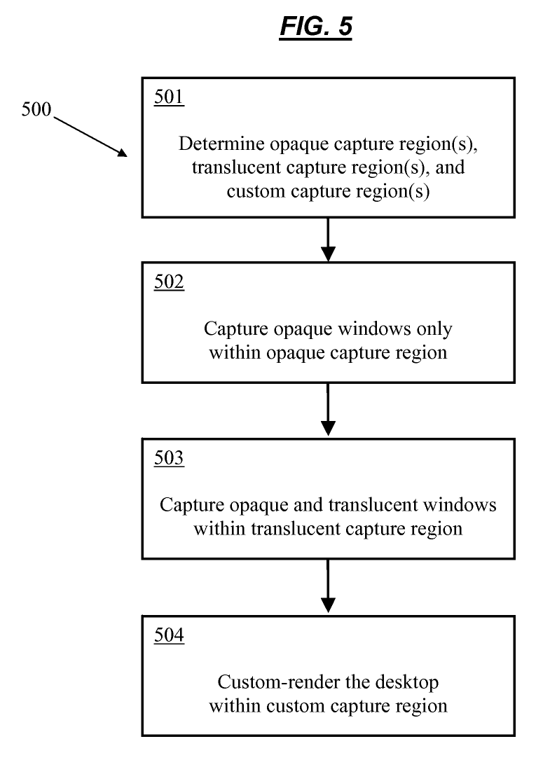

FIG. 5 is a flow chart illustrating the operation of a second embodiment 500 of the invention. The algorithm 500 determines regions in the desktop falling into one of three categories: an opaque capture region, a translucent capture region, and a custom capture region (Block 501). An opaque capture region is selected so as to exclude any translucent windows that are to be captured. A translucent capture region may include, in addition to opaque windows, also translucent windows to be captured, but not where they overlap with any translucent window to be excluded. Finally, a custom capture region may include any part of the desktop, including an area of overlap between a translucent window to be excluded and other translucent windows to be captured.

The algorithm applies an opaque capture method to opaque capture regions (Block 502). The opaque capture method only captures those areas associated with opaque windows. As mentioned above, desktop environments such as Microsoft Windows have the capability of capturing a rectangular area of the desktop without any of the translucent windows that may be present. While this method excludes the translucent windows that are intended to be excluded, it also excludes all other translucent windows as well. Accordingly, the opaque capture method may not be used in regions where any translucent windows to be captured are present. On the other hand, this method is very fast because it does not require blending of the contents of translucent and opaque windows.

Next, the algorithm applies a translucent capture method to translucent capture regions (Block 503). The translucent capture method captures both opaque and translucent windows in the region. This capture functionality is also provided by desktop environments such as Microsoft Windows. While this method includes all translucent windows that are meant to be included, it also includes the translucent window(s) that are meant to be excluded. Accordingly, the selection of the translucent capture region is made so as to exclude those translucent windows that are meant to be excluded. Regions including translucent windows to be excluded may be rendered using the custom capture method described below. This method is slower than the opaque capture method, but faster than the custom capture method.

Finally. the algorithm applies the custom capture method to custom capture regions. The custom capture algorithm re-renders the local desktop by capturing the contents of individual windows (i.e., those windows having their bounding boxes intersect with the region for capture) that are to be included in the transmitted desktop, and composing them in their z-order. While this method excludes only those windows that are meant to be excluded, it is slower than both the opaque capture method and the translucent capture method. Also, this functionality is generally not provided by standard desktop environments, and must typically be implemented at the application level. By optimizing the determination of the three regions, the fastest possible capture method is carried out in each region. Although the three methods have been described as being applied in a certain sequence, it is clear that any other sequence would be practicable.

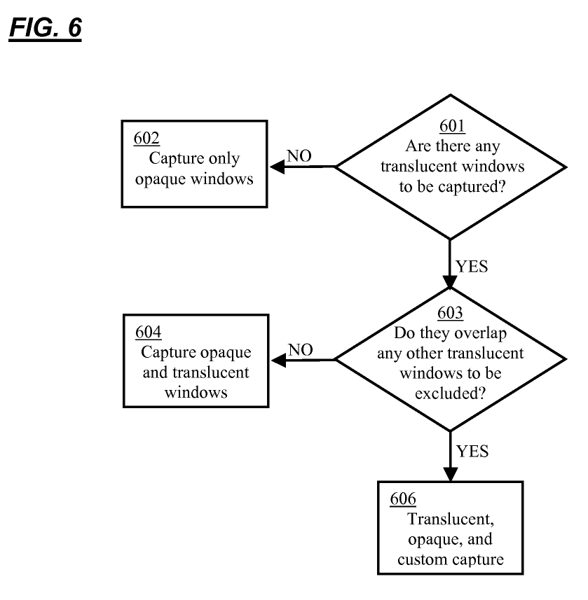

FIG. 6 is a flow chart describing the high-level operation of the second embodiment. If there are no translucent windows present in the entire desktop, save for those translucent windows to be excluded from the transmitted desktop (Block 601) then the opaque capture method is used (Block 602). If there are other translucent windows to be included in the transmitted desktop, and none overlap with a translucent window to be excluded from the desktop (Block 603), then both the opaque and the translucent capture methods are used, with the desktop appropriately partitioned into opaque and translucent capture regions (Block 604). Finally, if any translucent windows to be included in the transmitted desktop overlap with a translucent window to be excluded from the desktop, all three methods must be used, with the desktop appropriately partitioned into opaque, translucent, and custom capture regions (Block 606). In this way the algorithm selects an efficient set of methods to capture the desktop to be transmitted.

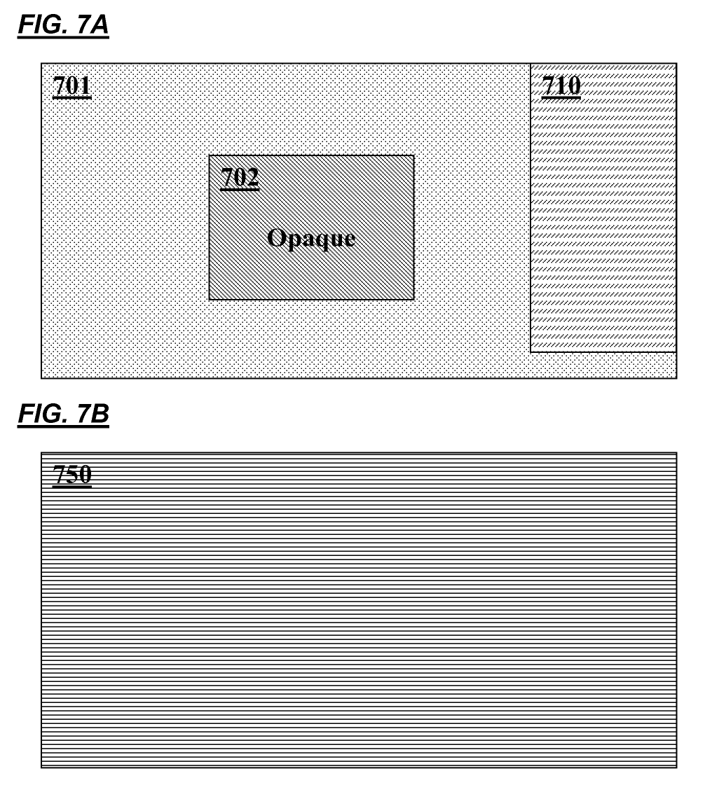

FIGS. 7A and 7B show the operation of the second embodiment of the invention in an exemplary case where only the opaque capture method is used. This corresponds to Block 602 in FIG. 6. The desktop only includes desktop background 701, one opaque window 702, and the translucent UI 710. In order to exclude the UI 710 from the transmitted desktop, it is only necessary to request from the operating system a copy of the desktop without translucent windows. In this particular case, the opaque capture region 750 in FIG. 7B encompasses the entire desktop.

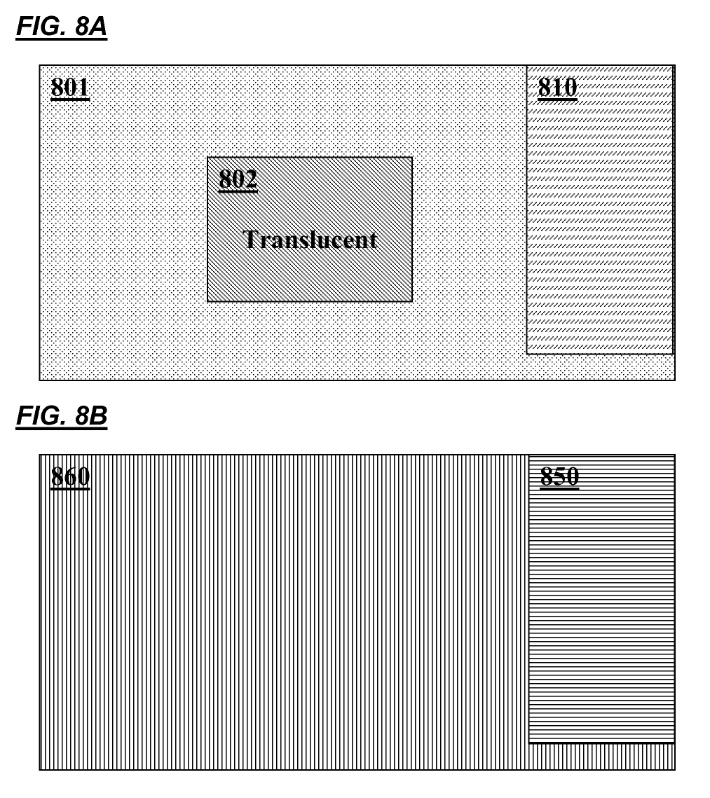

FIGS. 8A and 8B show the operation of the second embodiment of the invention in an exemplary case where both the opaque capture method and the translucent capture method are used. This corresponds to block 604 in FIG. 6. The desktop includes desktop background 801, one translucent window 802 and the translucent UI 810. The opaque capture method can still be used for the region corresponding to the UI 810, requesting from the operating system a copy of that region of the screen without translucent windows. However, due to the presence of the translucent window 802, the translucent capture method is used to capture the rest of the desktop, requesting from the operating system a copy of that region of the screen including both opaque and translucent windows. Accordingly, in FIG. 8B the opaque capture region 850 is limited to the area occupied by the UI 810, while the translucent capture region 860 covers the remaining area of the desktop 800.

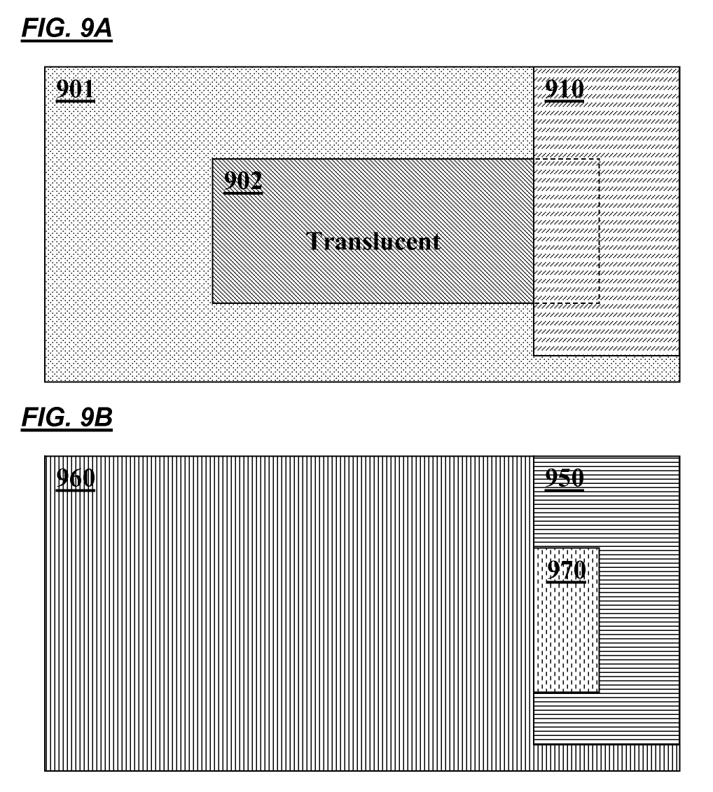

Finally, FIGS. 9A and 9B show the operation of the second embodiment of the invention in an exemplary case where all three methods (opaque capture, translucent capture, custom capture) are used. This corresponds to block 606 in FIG. 6. The desktop includes desktop background 901, the translucent UI 910, and one translucent window 902 overlapping with the UI 910. Now the opaque capture method can only be used over the part of the area of the UI that does not overlap with the translucent window. The rest of the area of the UI must be custom-rendered, and the remainder of the desktop is captured using the translucent capture method. Accordingly, in FIG. 9B the custom capture region 970 encompasses the overlap area between the UI 910 and the translucent window 902. The opaque capture region 950 encompasses the remaining area of the UI 910. The translucent capture region 960 covers the remaining area of the desktop 900.

### Dynamic Desktop Changes

Another aspect of the invention concerns the detection of changes in the desktop that cause the invocation of these algorithms. For example, the embodiments so far described rely on identifying regions of the desktop which are captured for communication to remote users utilizing different techniques. Since a computer desktop is a dynamic environment, the size and locations of these regions will change over time. Therefore, it is necessary to monitor the desktop to identify changes to the desktop that may require the recomputation of the regions for transmission.

Several types of changes to the desktop may require recomputation of the regions for transmission. The first type of changes include changes to the area covered by the UI (including its size, shape, or position). For example, when the boundaries of the UI area change, one or more of the regions for application of the various capture algorithms (opaque, translucent, or custom) may also change.

The second type of changes include changes in the number and position of translucent windows. For example, when translucent windows are created or destroyed, or otherwise moved around, the regions for application of the various capture algorithms (opaque, translucent, or custom) may also change.

The third type of changes include changes to the contents of the custom capture region. For example, in the second embodiment described above, the boundary between the opaque capture region and the custom capture region will partially coincide with the boundaries of any translucent window overlapping with the UI.

Accordingly, the capture regions determined may be updated upon the occurrence of certain events. For example, each time a desktop change is detected, the algorithm may determine if the capture scenario has changed and if the regions used by the capture algorithm are still valid. For example, if the user expands the area of the UI to access additional functions, the capture regions must be updated because the current capture regions might unintentionally capture part of the local user's UI.

In addition to event-triggered updates, it may be necessary to update the capture regions on a regular basis in order to detect certain kinds of changes. For example, if opaque capture is currently being used and a new translucent window appears on the desktop, this window will not be captured until the capture scenario has changed. Unfortunately, given that the region including the new translucent window is currently an opaque window, that would not happen until an opaque change was detected, and there is no guarantee that an opaque change would occur in a timely manner.

In order to detect such changes, a dedicated program thread may be used to determine, at regular intervals, if there have been changes of the three types mentioned above. If such a change has occurred, the screen capture apparatus may be notified and take appropriate action.

A dedicated program thread may also detect changes to the contents of a custom-rendered region. Since this region is not captured by either the opaque or translucent capture methods, changes to this region might go undetected indefinitely. To detect these changes, a dedicated program thread may periodically re-render the custom-capture region and compare the contents of the newly-rendered region image with a previously rendered reference image for the region. Typically rendering time is roughly proportional to the number of windows involved, and with many windows a custom rendering process may involve a significant amount of CPU time. Accordingly, given the potentially significant computational expense of custom rendering, this type of re-rendering and comparison is typically done independent of the normal screen capture activities and less frequently. At the same time, however, the frequency of re-rendering and comparison should be high enough so that a user will not detect errors in the transmitted desktop. For example, custom re-rendering and comparison may be performed one or two times per second.

Although the invention has been described in detail including several embodiments thereof, such description is for illustrative purposes only, and it is to be understood that changes, variations and improvements may be made by those skilled in the art while still remaining within the scope of the invention currently described. In particular, the invention is clearly not limited to capturing a view of the local desktop that excludes a single translucent window. In fact, it can be used in a straightforward manner to exclude one or more windows, and the windows can be translucent, opaque, or a mix of translucent and opaque windows. Moreover, exemplary embodiments of the invention have been described with reference to specific capture techniques such as utilizing a frame buffer or operating system calls, however the invention will equally apply to capture techniques relying on direct communication with a graphics processing unit (GPU), reception of a desktop image from another computer over a network, etc.

I claim:

1. A method for the display of an image at a remote computer, the image including a graphical object to be at least partially omitted from the image displayed at the remote computer, the method comprising:
determining a first region in the image, the first region comprising at least part of the graphical object;
selectively capturing pixels that fall outside the first region; and
selectively re-rendering pixels that fall within the first region to omit the graphical object.

2. The method of claim 1, wherein the first region comprises the entirety of the graphical object.

3. The method of claim 2, wherein the first region coincides with the area of the image that is covered by the graphical object.

4. The method of claim 1, wherein the image comprises opaque and translucent objects, and the graphical object is a translucent object.

5. The method of claim 4, further comprising:
determining a second region in the image, the second region comprising translucent objects not overlapping with the graphical object;
determining a third region in the image, the third region not comprising translucent objects;
selectively capturing pixels of the second region including both opaque and translucent objects; and
selectively capturing pixels of the third region including opaque objects only.

6. The method of claim 4, wherein the opaque and translucent objects are arranged in a hierarchy, and wherein the step of re-rendering pixels comprises:
retrieving the contents of each opaque and translucent object that intersects the first region; and
composing the contents according to their order in the hierarchy and their being opaque or translucent.

7. The method of claim 1, further comprising:
updating the first region in response to changes in the graphical object.

8. The method of claim 1, further comprising:
updating the first region at predetermined times.

9. The method of claim 5, further comprising:
updating at least one of the first, second and third regions in response to changes in the number and position of translucent objects.

10. The method of claim 5, further comprising:
selectively rendering updated pixels in the first region;
detecting a change by comparing the updated pixels with previously rendered pixels; and
if a change is detected, updating at least one of the first, second and third regions.

11. The method of claim 10, wherein:
the image is captured at a first average frequency; and
the step of selectively rendering updated pixels is performed at a second average frequency which is substantially lower than the first average frequency.

12. The method of claim 1, wherein:
the image represents a desktop of a local computer system; and
the graphical object represents the user interface of an application running on the local computer system.

13. An apparatus for the display of an image at a remote computer, the image including a graphical object to be at least partially omitted from the image displayed at the remote computer, the apparatus comprising:
a facility for determining a first region in the image, the first region comprising at least part of the graphical object;
a facility for selectively capturing pixels that fall outside the first region; and
a facility for selectively re-rendering pixels that fall within the first region to omit the graphical object.

14. A computer-readable medium storing a program for the display of an image at a remote computer, the image including a graphical object to be at least partially omitted from the image displayed at the remote computer, the program comprising instructions for:
determining a first region in the image, the first region comprising at least part of the graphical object;
selectively capturing pixels that fall outside the first region; and
selectively re-rendering pixels that fall within the first region to omit the graphical object.
